(19) United States
(12) Patent Application Publication
(10) Pub. No.: US 2026/0301653 A1
(43) Pub. Date: Oct. 1, 2026

(54) DISPLAY DEVICE AND METHOD OF DRIVING DISPLAY DEVICE

(71) Applicant: LG Display Co., Ltd., Seoul (KR)

(72) Inventors: Uitaek JEONG, Paju-si (KR); Mookyoung HONG, Paju-si (KR)

(73) Assignee: LG Display Co., Ltd., Seoul (KR)

(21) Appl. No.: 19/431,152

(22) Filed: Dec. 23, 2025

(30) Foreign Application Priority Data
Mar. 28, 2025 (KR) 10-2025-0040491

(51) Int. Cl. G09G 3/32

(52) U.S. Cl. CPC G09G 3/32; G09G 2300/0819; G09G 2310/0267; G09G 2310/0275; G09G 2310/08; G09G 2320/0233; G09G 2320/0247; G09G 2320/041; G09G 2320/045; G09G 2330/021

(57) ABSTRACT

Embodiments relates to a display device and a method of driving a display device, and the display device includes a display panel on which pixels are disposed, a gate driving circuit configured to apply a gate signal to the pixels through a gate line, a data driving circuit configured to convert image data and apply the converted image data to the pixels through a data line, and convert sensing signals output from the pixels through a readout line into sensing data and output the sensing data, and a timing controller configured to control an output of the image data based on a sensing value of the sensing data, wherein the timing controller increases an output period of the image data on a frame-by-frame basis when the sensing value is greater than or equal to a preset threshold value.

### CROSS REFERENCE TO RELATED APPLICATION

The present application claims priority to Korean Patent Application No. 10-2025-0040491, filed Mar. 28, 2025, the entire contents of which is incorporated herein for all purposes by this reference.

### BACKGROUND

### Technical Field

The present disclosure relates to a display device and a method of driving a display device.

### Description of the Related Art

A display device displays images through a plurality of pixels disposed on a display panel. Each pixel includes a light-emitting element and a pixel circuit that controls a driving current flowing in the light-emitting element. The pixel circuit charges a data voltage applied to a data line in response to a gate signal applied through a gate line, and the light-emitting element emits light with a luminance corresponding to the data voltage.

Typically, one data line is disposed per pixel column. However, as performance requirements of the display device are improved and large-area, high-resolution display devices emerge, various structures in which a single data line is shared by a plurality of pixel columns are being developed.

As an area and resolution of the display panel increase, the amount of data voltage applied to the display panel increases, and data voltage transitions occur more frequently in complex data line-sharing structures. Accordingly, temperatures of a data driving circuit that supplies the data voltage to the display panel and the display panel also increase.

### BRIEF SUMMARY

Embodiments are directed to a display device capable of reducing a temperature rise of a display panel, and a method of driving a display device.

Embodiments are also directed to a display device capable of predicting a temperature of a data driving circuit based on sensing data acquired through pixel sensing and controlling an output period of image data based on the predicted temperature, and a method of controlling a display device.

Embodiments are also directed to a display device capable of predicting a temperature of a data driving circuit based on sensing data acquired through pixel sensing and controlling a voltage level, frequency, and/or refresh rate of image data based on the predicted temperature, and a method of controlling a display device.

According to one embodiment, a display device includes a display panel on which pixels are disposed, a gate driving circuit configured to apply a gate signal to the pixels through a gate line, a data driving circuit configured to convert image data and apply the converted image data to the pixels through a data line, and convert sensing signals output from the pixels through a readout line into sensing data and output the sensing data, and a timing controller configured to control an output of the image data based on a sensing value of the sensing data.

The timing controller increases an output period of the image data on a frame-by-frame basis when the sensing value is greater than or equal to a preset threshold value.

The sensing value may vary depending on a temperature of the data driving circuit.

The data driving circuit may include a plurality of source driving integrated circuits, each of which generates sensing data for corresponding pixels.

When the sensing values of at least some of the plurality of source driving integrated circuits are greater than or equal to the preset threshold value, the timing controller may control an output period of the image data for the at least some of the source driving integrated circuits with a second frame period and control an output period of the image data for the remaining ones of the source driving integrated circuits with a first frame period.

The first frame period may include one frame, and the second frame period may include two or more frames.

The two or more frames may include a first frame in which the data voltage is programmed in the pixels, and at least one second frame in which the data voltage is not programmed in the pixels.

Each of the pixels may include a driving transistor connected between a high potential driving voltage and a second node and having a gate electrode connected to a first node, a first transistor connected between a corresponding data line and the first node and having a gate electrode receiving a scan signal through a first gate line, a second transistor connected between the readout line and the second node and having a gate electrode receiving a sensing signal through a second gate line, and a light-emitting element connected between the second node and a low potential driving voltage.

The first frame may include a first time in which the scan signal at a turn-on level is applied to the first gate line, the sensing signal at a turn-on level is applied to the second gate line, and a reference voltage is applied to the readout line, a second time in which the data voltage is applied to the data line, a third time in which the scan signal and the sensing signal are applied at a turn-off level, and voltages of the first node and the second node are increased, and a fourth time in which the light-emitting element emits light. Here, the first time is interchangeable with the first period of time, the second time is interchangeable with the second period of time, the third time is interchangeable with the third period of time, and the fourth time is interchangeable with the fourth period of time.

The second frame may include a fifth time in which the sensing signal at a turn-on level is applied to the second gate line and a reference voltage is applied to the readout line, a sixth time in which the sensing signal is applied at a turn-off level and voltages of the first node and the second node increase, and a seventh time in which the light-emitting element emits light. Here, the fifth time is interchangeable with the fifth period of time, the sixth time is interchangeable with the sixth period of time, and the seventh time is interchangeable with the seventh period of time.

While the output period of the image data for the plurality of source driving integrated circuits varies, a driving frequency of the display panel may be fixed.

In the display device, at least two pixels disposed in different pixel columns may be electrically connected to the data driving circuit through a single data line.

The timing controller may further vary at least one of a voltage level and a frequency of the image data based on the sensing value.

When the sensing value is greater than or equal to the preset threshold value, the timing controller may decrease a high level of the image data or increase a low level of the image data.

When the sensing value is greater than or equal to the preset threshold value, the timing controller may decrease the frequency of the image data.

According to one embodiment, there is provided a method of driving a display device, including controlling the data driving circuit to sense electrical characteristics of the pixels, varying an output period of the image data on a frame-by-frame basis in response to sensing values collected through the sensing, and programming, by the data driving circuit, a data voltage in the pixels according to the varied output period.

The varying of the output period of the image data may include comparing the sensing value with a preset threshold value, and increasing an output period of the image data when the sensing value is greater than or equal to the preset threshold value.

The data driving circuit may include a plurality of source driving integrated circuits, each of which generates sensing data for corresponding pixels.

The varying of the output period of the image data may include controlling an output period of the image data for at least some of the source driving integrated circuits with a second frame period when sensing values of the at least some of the plurality of source driving integrated circuits are greater than or equal to the preset threshold value, and controlling the output period of the image data for the remaining ones of the source driving integrated circuits with a first frame period.

The first frame period may include one frame, and the second frame period may include two or more frames.

The two or more frames may include a first frame in which the data voltage is programmed in the pixels, and at least one second frame in which the data voltage is not programmed in the pixels.

Each of the pixels may include a driving transistor connected between a high potential driving voltage and a second node and having a gate electrode connected to a first node, a first transistor connected between a corresponding data line and the first node and having a gate electrode receiving a scan signal through a first gate line, a second transistor connected between the readout line and the second node and having a gate electrode receiving a sensing signal through a second gate line, and a light-emitting element connected between the second node and a low potential driving voltage.

The programming of the data voltage in the pixels may include, during the first frame, applying a scan signal at a turn-on level to the first gate line, a sensing signal at a turn-on level to the second gate line, and a reference voltage to the read-out line, applying the data voltage to the data line, increasing voltages of the first node and the second node by applying the scan signal and the sensing signal at a turn-off level, and causing the light-emitting element to emit light.

The programming of the data voltage in the pixels may include, during the second frame, applying a sensing signal at a turn-on level to the second gate line and applying a reference voltage to the readout line, increasing the voltages of the first node and the second node by applying the sensing signal at a turn-off level, and causing the light-emitting element to emit light.

### BRIEF DESCRIPTION OF THE SEVERAL VIEWS OF THE DRAWINGS

FIG. 1 is a block diagram illustrating a configuration of a display device according to one embodiment.

FIG. 2 is a view illustrating a system of the display device according to one embodiment.

FIG. 3 is a block diagram illustrating a configuration of a data driving circuit according to one embodiment.

FIG. 4 is a view illustrating a connection relationship between a pixel, a data driver, and a timing controller according to one embodiment.

FIG. 5 is a timing diagram illustrating a method of driving a pixel according to one embodiment.

FIG. 6 is a view illustrating a threshold voltage sensing method for a driving transistor of the display device according to one embodiment.

FIG. 7 is a view for describing a mobility sensing method for the driving transistor of the display device according to one embodiment.

FIG. 8 is a view illustrating a pixel structure driven using a double rate driving (DRD) method in the display device according to one embodiment.

FIG. 9 is a block diagram illustrating some components of the display device according to one embodiment.

FIG. 10 is a view illustrating a change in a sensing value of sensing data according to a change in temperature of a data driver circuit.

FIG. 11 is a view illustrating a method of varying a period of image data according to one embodiment.

FIG. 12 is a timing diagram illustrating a pixel driving method using the method of varying a period of an image data.

FIG. 13 is a view illustrating an example of a connection structure between a plurality of source driving integrated circuits disposed on a source printed circuit board and a timing controller disposed on a control printed circuit board.

FIG. 14 is a view illustrating a method of varying a period of image data for the source driving integrated circuits illustrated in FIG. 13.

FIG. 15 is a view illustrating a method of varying a voltage level of the image data according to one embodiment.

FIG. 16 is a view illustrating a method of varying a frequency of the image data according to one embodiment.

FIG. 17 is a flowchart illustrating a method of driving a display device according to one embodiment.

### DETAILED DESCRIPTION

Hereinafter, embodiments will be described with reference to the accompanying drawings. In the specification, when a certain component (or an area, a layer, a portion, etc.) is described as “on,” “connected,” or “coupled to” another component, it means that the certain component may be directly connected/coupled to another component or still another component may be disposed therebetween.

The same reference numerals indicate the same components. In addition, in the drawings, thicknesses, proportions, and dimensions of components are exaggerated for effective description of technical contents. The term “and/or” includes all one or more combinations that may be defined by the associated configurations.

Terms such as “first,” “second,” and the like may be used to describe various components, but the components are not limited by the terms. The terms are used only for the purpose of distinguishing one component from another. For example, a first component may be referred to as a second component, and similarly, the second component may also be referred to as the first component without departing from the scopes of the embodiments. The singular includes the plural unless the context clearly dictates otherwise.

Terms such as “under,” “at a lower side,” “above,” and “at an upper side” are used to describe the relationship between the components illustrated in the drawings. The terms are relative concepts and are described with respect to directions marked in the drawings.

It should be understood that term such as “includes” or “has” is intended to specify the presence of features, numbers, steps, operations, components, parts, or a combination thereof described in the specification and does not preclude the presence or addition possibility of one or more other features, numbers, steps, operations, components, parts, or combinations thereof.

In the description of the temporal flow relationship related to components, operation methods, manufacturing methods, and the like, for example, the temporal sequence relationship or the flow sequence relationship, such as “after,” “subsequent to,” “then,” or “before,” it may also include a non-continuous case unless “immediately” or “directly” is used.

Meanwhile, in case that numerical values of components or the corresponding information (e.g., a level) are described, even when there is no separate explicit description, the numerical values or the corresponding information can be construed as including a range of error that may occur due to various factors (e.g., process factors, an internal or external impact, and noise).

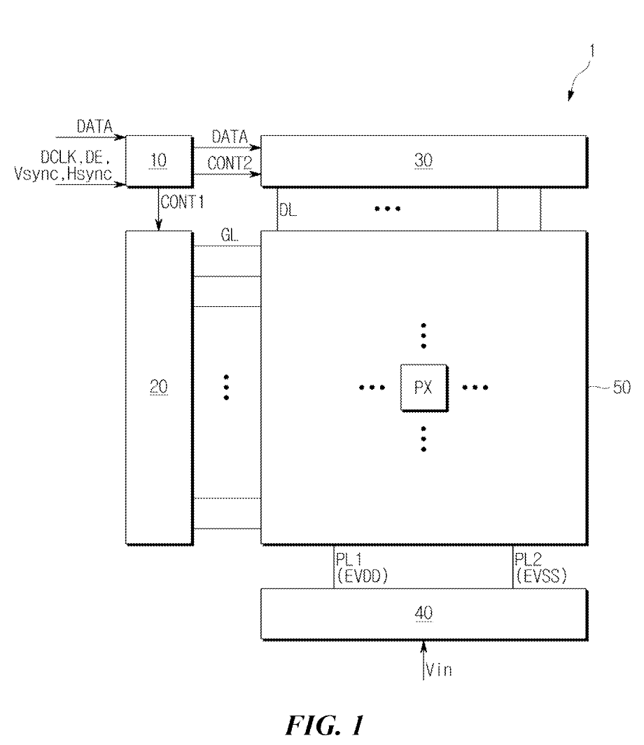

FIG. 1 is a block diagram illustrating a configuration of a display device according to one embodiment.

Referring to FIG. 1, a display device 1 includes a timing controller 10, a gate driving circuit 20, a data driving circuit 30, a power supply unit 40, and a display panel 50.

The timing controller 10 may receive image data DATA and synchronization signals from an external host system or the like. The image data DATA may include a plurality of grayscale data. The synchronization signals may include, for example, a dot clock DCLK that determines a transmission speed of the image data DATA, a data enable signal DE that indicates a valid section of the image data DATA, a vertical synchronization signal Vsync that defines the time of one frame, and a horizontal synchronization signal Hsync that defines a horizontal time for programming a data voltage Vdata to one pixel row within one frame.

The timing controller 10 may process the image data DATA and the synchronization signals according to operating conditions of the display panel 50. The timing controller 10 may generate and output a gate driving control signal CONT1 and a data driving control signal CONT2 based on the synchronization signals.

The gate driving circuit 20 may generate gate signals based on the gate driving control signal CONT1 output from the timing controller 10. The gate driving control signal CONT1 may include a gate start pulse GSP, a gate clock GCLK, a gate output enable signal GOE, etc. The gate start pulse controls the timing at which one or more gate driving integrated circuits constituting the gate driving circuit 20 begin their operations. The gate clock is a clock signal commonly input to the one or more gate driving integrated circuits and controls the shift timing of the gate signals. The gate output enable signal specifies timing information for the one or more gate driving integrated circuits.

The gate driving circuit 20 may provide the generated gate signals to pixels PX through a plurality of gate lines GL. In one embodiment, one pixel PX may be configured to receive a plurality of gate signals with different waveforms.

In this embodiment, the gate driving circuit 20 may provide the plurality of gate signals to the pixels PX in a corresponding pixel row through the gate lines GL. For example, when the display panel 50 has an n×m resolution, the gate driving circuit 20 may be connected to n gate lines GL and may sequentially output gate signals from a first gate line to an n^{th} gate line. Such a driving method may be referred to as an n-phase driving method.

The gate driving circuit 20 may be formed in a form of a gate in panel (GIP) on the display panel 50. The gate driving circuit 20 may be disposed at one side of the display panel 50, as illustrated, or at both sides (e.g., left and right sides) of the display panel 50. According to a driving method, a panel design method, and the like, the gate driving circuit 20 may be disposed at both sides (e.g., left and right sides) of the display panel 50 or connected to two or more of four side surfaces of the display panel 50.

The data driving circuit 30 may generate data signals based on the image data DATA and the data driving control signal CONT2 that are output from the timing controller 10. The data driving control signal CONT2 may include a source start pulse SSP, a source sampling clock SCLK, a source output enable signal SOE, etc. The source start pulse controls the timing at which one or more source driving integrated circuits constituting the data driving circuit 30 begin data sampling. The source sampling clock is a clock signal that controls the timing that the source driving integrated circuit samples data. The source output enable signal controls the output timing of the data driving circuit 30.

The data driving circuit 30 may provide the generated data signals to the pixels PX through a plurality of data lines DL. For example, when the display panel 50 has an n×m resolution, the data driving circuit 30 may be connected to m data lines and may sequentially output data voltages on a pixel row basis.

The data driving circuit 30 may include one or more source driving integrated circuits SDIC. In one embodiment, the source driving integrated circuits may be integrated into the display panel 50. In another embodiment, the source driving integrated circuits may be connected to bonding pads of the display panel 50 using a tape automated bonding (TAB) method or a chip on glass (COG) method. In still another embodiment, each source driving integrated circuit may be implemented using a chip on film (COF) method. In this embodiment, each source driving integrated circuit may be mounted on a circuit film and electrically connected to a data line DL on the display panel 50 through the circuit film.

The power supply unit 40 adjusts a DC input voltage Vin supplied from a host system or the like to generate the power required to drive the display panel 50, the gate driving circuit 20, and the data driving circuit 30. For example, the power supply unit 40 may generate a high potential driving voltage EVDD and a low potential driving voltage EVSS, which will be provided to the display panel 50.

The power supply unit 40 may provide the generated driving voltages EVDD and EVSS to the pixels PX through corresponding voltage lines PL1 and PL2. In addition, the power supply unit 40 may further generate a reference voltage and the like required for driving the pixels PX and provide the reference voltage and the like to the pixels PX through the corresponding voltage lines.

A plurality of pixels PX (or referred to as sub-pixels) are disposed on the display panel 50. For example, the pixels PX may be arranged in a form of a matrix on the display panel 50. Pixels PX disposed in one pixel row are connected to the same gate line GL, and pixels PX disposed in one pixel column are connected to the same data line DL. The pixels PX may emit light with luminance corresponding to the gate signal and data signal supplied through the gate lines GL and the data lines DL.

In one embodiment, each pixel PX may display one of red, green, and blue. In another embodiment, each pixel PX may display one of cyan, magenta, and yellow. In various embodiments, each pixel PX may display one of red, green, blue, and white.

When the display device 1 is a liquid crystal display (LCD) device, the display panel 50 may include a liquid crystal layer formed between two substrates and may be driven in a twisted nematic (TN) mode, a vertical alignment (VA) mode, an in plane switching (IPS) mode, a fringe field switching (FFS) mode, etc. When the display device 1 is an organic light emitting display device, the display panel 50 may be driven in a top emission method, a bottom emission method, a dual emission method, etc.

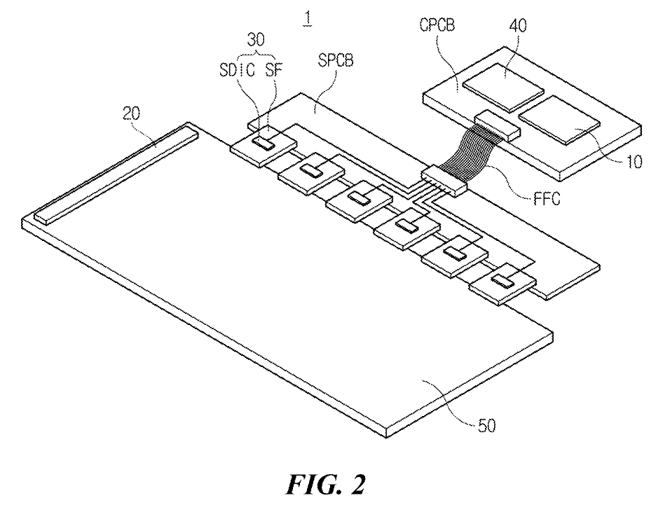

FIG. 2 is a view illustrating a system of the display device according to one embodiment.

Referring to FIG. 2, in the display device 1 according to one embodiment, the source driving integrated circuit SDIC constituting the data driving circuit 30 and a gate driving integrated circuit GDIC constituting the gate driving circuit 20 may be implemented using a COF method among various methods (TAB, COG, COF, etc.).

The gate driving circuit 20 may be mounted at one side of the display panel 50 using a GIP method. The gate driving circuit 20 may be disposed at one side of the display panel 50, as illustrated, or at both sides (e.g., left and right sides) of the display panel 50. According to a driving method, a panel design method, and the like, the gate driving circuit 20 may be disposed at both sides (e.g., left and right sides) of the display panel 50 or connected to two or more of four side surfaces of the display panel 50.

Likewise, each of one or more source driving integrated circuits SDIC included in the data driving circuit 30 may be mounted on a source film SF, and one side of the source film SF may be electrically connected to the display panel 50. In addition, wires for electrically connecting the source driving integrated circuit SDIC with the display panel 50 may be disposed on the source film SF.

The display device 1 may include at least one source printed circuit board SPCB and a control printed circuit board CPCB for mounting control components and various electrical devices.

The other side of the source film SF at which the source driving integrated circuit SDIC is mounted may be connected to the at least one source printed circuit board SPCB. That is, the one side of the source film SF may be electrically connected to the display panel 50, and the other side may be electrically connected to the source printed circuit board SPCB.

The timing controller 10 and the power supply unit 40 may be mounted on the control printed circuit board CPCB. The control printed circuit board CPCB may be electrically connected to the source printed circuit board SPCB via a flexible flat cable FFC or a flexible printed circuit.

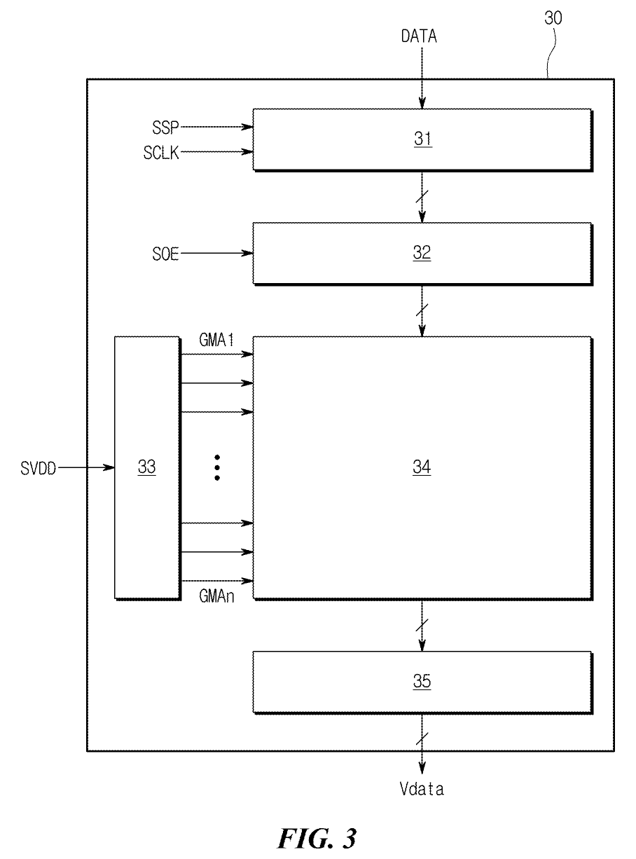

FIG. 3 is a block diagram illustrating a configuration of a data driving circuit according to one embodiment. For example, FIG. 3 illustrates a structure of one source driving integrated circuit SDIC constituting the data driving circuit 30.

Referring to FIG. 3, the data driving circuit 30 according to one embodiment may include a shift register 31, a latch circuit 32, a gamma circuit 33, a digital-to-analog converter 34, and an output buffer 35.

The shift register 31 may shift and simultaneously output the image data DATA received as serial data in response to the source start pulse SSP and the source sampling clock SCLK transmitted from the timing controller 10. Here, the source start pulse SSP may control a data sampling start time point of the data driving circuit 30, and the source sampling clock SCLK may control sampling timing.

When the source start pulse SSP instructs the start of the data sampling, the shift register 31 may output the image data DATA in synchronization with a rising or falling edge of the source sampling clock SCLK. Through the shift register 31, the image data DATA, which is serial data, is converted into parallel data and supplied to the latch circuit 32.

The latch circuit 32 may latch the image data DATA output from the shift register 31 and then output the image data DATA to the digital-to-analog converter 34 in response to a source output enable signal SOE. Through the latch circuit 32, the image data DATA corresponding to one line may be simultaneously applied to the source driving integrated circuits SDIC. One latch circuit 32 is illustrated in FIG. 3, but two or more latch circuits 32 may be formed.

The gamma circuit 33 generates first to n^{th} gamma reference voltages GMA1 to GMAn using a gamma driving power supply SVDD supplied from the timing controller 10.

The digital-to-analog converter 34 converts digital image data DATA into analog data voltages Vdata based on the first to n^{th} gamma reference voltages GMA1 to GMAn transmitted from the gamma circuit 33.

The output buffer 35 amplifies or compensates for the data voltage Vdata transmitted from the analog-to-digital converter 34 and supplies the data voltage Vdata to each data line DL.

Power supplies for the gamma circuit 33, the digital-to-analog converter 34, and the output buffer 35 may be separate from each other or may share a single gamma driving power supply SVDD.

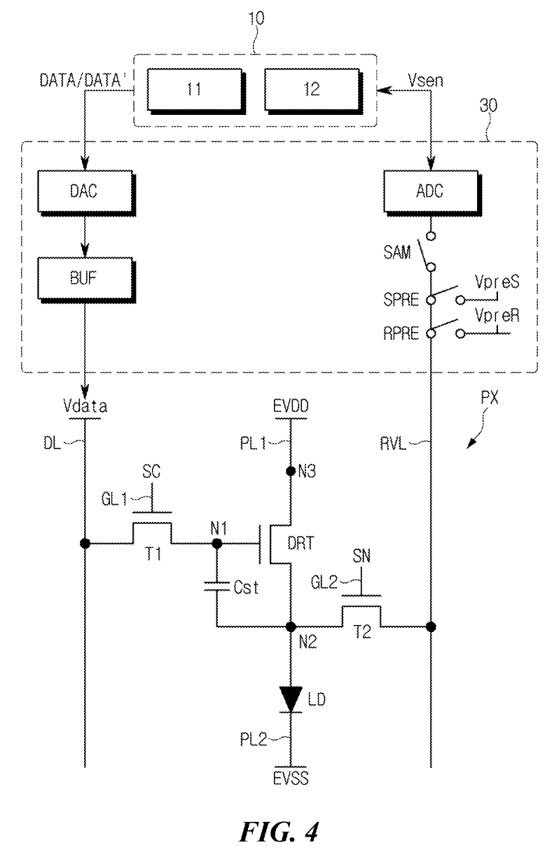

FIG. 4 is a view illustrating a connection relationship between a pixel, a data driver, and a timing controller according to one embodiment.

Referring to FIG. 4, the pixel PX according to one embodiment may include a driving transistor DRT, a light-emitting element LD connected to the driving transistor DRT, and a control circuit for controlling the amount of driving current to be applied to the light-emitting element LD through the driving transistor DRT. For example, the control circuit may include first and second transistors T1 and T2 and a storage capacitor Cst.

A first electrode of the driving transistor DRT is formed to receive the high potential driving voltage EVDD (connected to the high potential driving voltage line PL1), and a second electrode thereof is connected to the light-emitting element LD via a second node N2. A gate electrode of the driving transistor DRT is connected to a first node N1. The driving transistor DRT may be turned on according to a voltage applied to the first node N1 to control the amount of driving current flowing from the high-potential driving voltage EVDD to the light-emitting element LD.

A first electrode of a first transistor T1 is connected to the data line DL, and a second electrode thereof is connected to the gate electrode of the driving transistor DRT via the first node N1. A gate electrode of the first transistor T1 may be connected to a first gate line GL1 to receive a first gate signal. The first gate signal is a scan signal SC and may be a control signal applied to program a data voltage Vdata in the pixel PX.

The first transistor T1 may be turned on according to the scan signal SC applied to the first gate line GL1 to transmit the data voltage Vdata applied to the data line DL to the first node N1. The first transistor T1 may be referred to as “switching transistor.”

A first electrode of the second transistor T2 is connected to a readout line RVL, and a second electrode thereof is connected to the second node N2. A gate electrode of the second transistor T2 may be connected to a second gate line GL2 to receive a second gate signal. The second gate signal may be a sensing signal SN and may be a control signal applied to apply a reference voltage to the pixel PX or sense the electrical characteristics of the pixel PX.

The second transistor T2 may be turned on in response to the sensing signal SN applied to the second gate line GL2 to electrically connect the readout line RVL to the second node N2. When a display reference voltage VpreR or a sensing reference voltage VpreS is applied to the readout line RVL, the display reference voltage VpreR or the sensing reference voltage VpreS may be applied to the second node N2 through the turned-on second transistor T2.

When the readout line RVL is not connected to the reference voltages VpreR and VpreS, the sensing signal (e.g., current, voltage) applied to the second node N2 may flow through the readout line RVL and may be transmitted to the data driving circuit 30 (see FIG. 1) and/or the timing controller 10 (see FIG. 1). The transmitted sensing signal may be used to detect the electrical characteristics of the pixel PX. The second transistor T2 may be referred to as an initialization transistor and/or a sensing transistor.

The storage capacitor Cst is connected between the first node N1 and the second node N2. The storage capacitor Cst may store a voltage corresponding to a difference in voltage between the first node N1 and the second node N2, that is, a gate-source voltage Vgs of the driving transistor DRT. For example, the storage capacitor Cst may store a voltage corresponding to a difference in voltage between the data voltage Vdata applied to the data line DL and the second node N2 and maintain the stored voltage during one frame, thereby stabilizing the gate-source voltage of the driving transistor DRT.

The light-emitting element LD may have an anode electrode connected to the second node N2 and a cathode electrode connected to the low potential driving voltage line PL2 (configured to receive the low potential driving voltage EVSS). When the driving transistor DRT is turned on, a current path may be formed between the high potential driving voltage EVDD and the low potential driving voltage EVSS so that the driving current may flow to the light-emitting element LD. The light emitting element LD may emit light with luminance corresponding to the amount of driving current applied.

In the embodiment illustrated in FIG. 4, the pixel PX may be formed of an N-type transistor. In this embodiment, the transistors DRT, T1, and T2 may be turned on when the gate signal is at a high level and turned off when the gate signal is at a low level.

In another embodiment, the pixel PX may be formed of a P-type transistor. In this embodiment, the transistors DRT, T1, and T2 may be turned on when the gate signal is at a low level and turned off when the gate signal is at a high level. In still another embodiment, the pixel PX may be of a hybrid type including both the N-type and P-type transistors.

The display device 1 may include a compensation unit 11 for determining a characteristic value of the pixel PX using sensing data Vsen acquired by sensing the pixel PX and performing a compensation process to compensate for the characteristic value and a memory 12 for storing the compensation value generated by the compensation unit 11. The compensation unit 11 and the memory 12 may be provided within the timing controller 10.

In this embodiment, the data driving circuit 30 may further include an analog-to-digital converter ADC for converting a voltage measured through the readout line RVL into digital data, a sampling switch SAM for controlling connection between the analog-to-digital converter ADC and the readout line RVL, a display reference voltage switch RPRE for controlling connection between the readout line RVL and the display reference voltage VpreR, and a sensing reference voltage switch SPRE for controlling connection between the readout line RVL and the sensing reference voltage VpreS.

The sensing reference voltage switch SPRE and the display reference voltage switch RPRE may be provided separately or may be implemented as one integrated unit. The sensing reference voltage VpreS and the display reference voltage VpreR may be the same voltage value or different voltage values.

The sensing reference voltage switch SPRE may control a voltage application state of the second node N2 of the driving transistor DRT within the pixel PX so that the second node N2 of the driving transistor DRT becomes a voltage state reflecting a characteristic value of a desired circuit element(such as the driving transistor DRT and/or the light-emitting element LD). When the sensing reference voltage switch SPRE is turned on, the sensing reference voltage VpreS may be supplied to the readout line RVL and applied to the second node N2 of the driving transistor DRT through the turned-on second transistor T2.

The sampling switch SAM is turned on to electrically connect the readout line RVL to the analog-to-digital converter ADC. The sampling switch SAM may be controlled to be turned on when the second node N2 within the pixel PX becomes a voltage state reflecting the characteristic value of the desired circuit element(such as the driving transistor DRT and/or the light-emitting element LD).

When the sampling switch SAM is turned on, the analog-to-digital converter ADC may convert the voltage of the connected readout line RVL into digital data to generate the sensing data Vsen and transmit the sensing data Vsen to the timing controller 10.

The analog-to-digital converter ADC, the sampling switch SAM, the sensing reference voltage switch SPRE, and the display reference voltage switch RPRE may be provided within the data driving circuit 30, but are not limited thereto.

The timing controller 10 may determine the characteristic values (e.g., threshold voltage, mobility, and the like) of circuit elements (e.g., the driving transistor DRT and/or the light-emitting element LD) within the corresponding pixel PX based on the sensing data Vsen and perform an external compensation process for the characteristic values.

Specifically, the compensation unit 11 may calculate compensation values (e.g., offset, gain, and the like) for characteristic value compensation based on the sensing data Vsen and transmit image data DATA′ with the compensation value applied to the data driving circuit 30. The data driving circuit 30 may convert the compensated image data DATA′ into the data voltage Vdata in the form of an analog signal through a digital-to-analog converter DAC and output the data voltage Vdata to the corresponding data line DL through an output buffer BUF. As such characteristic value compensation is performed, a luminance deviation between the pixels PX can be reduced, thereby improving image quality.

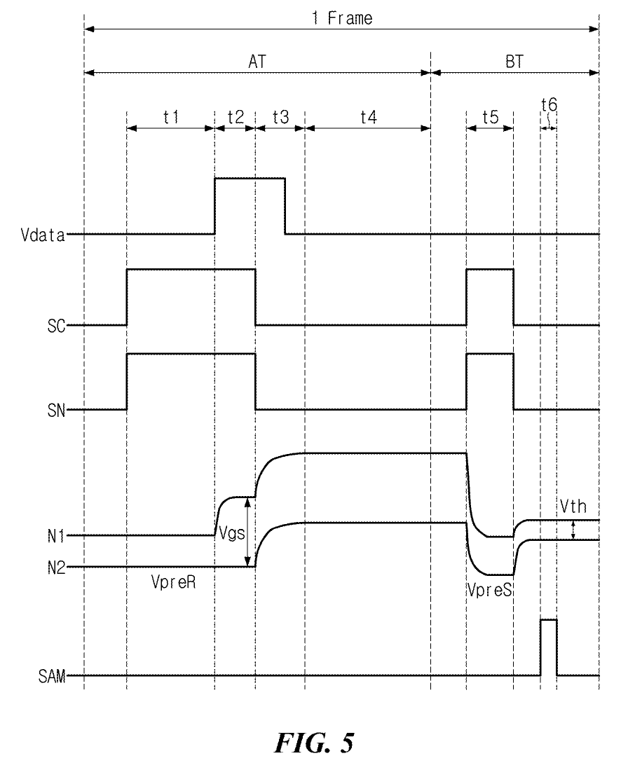

FIG. 5 is a timing diagram illustrating a method of driving a pixel according to one embodiment.

Referring to FIGS. 4 and 5 together, the pixel PX may be driven on a frame-by-frame basis. One frame may include an active time AT (display driving time) for displaying an image and a blank time BT (sensing driving time) subsequent to the active time.

During the active time AT, the data voltage Vdata may be programmed in the pixel PX, and the light-emitting element LD may emit light with luminance corresponding to the data voltage Vdata. The active time AT may include an initialization time t1, a programming time t2, a tracking time t3, and a light emission time t4.

During the initialization time t1, the second transistor T2 is turned on, and the display reference voltage switch RPRE is turned on by the sensing signal SN at a turn-on level. Accordingly, the second node N2 may be initialized to the display reference voltage VpreR.

During the programming time t2, the first transistor T1 is turned on by the scan signal SC at a turn-on level, and the data voltage Vdata is applied to the data line DL. Accordingly, the data voltage Vdata is programmed in the first node N1 of the driving transistor DRT. The voltage of the second node N2 is maintained at the display reference voltage VpreR by the turned-on second transistor T2.

During the programming time t2, the gate-source voltage Vgs of the driving transistor DRT is programmed to a difference between the data voltage Vdata and the display reference voltage VpreR. The programmed voltage may be stored in the storage capacitor Cst. In this case, the gate-source voltage Vgs is higher than a threshold voltage of the driving transistor DRT, and the driving transistor DRT may be turned on.

During the tracking time t3, the scan signal SC at the turn-off level and the sensing signal SN at the turn-off level are applied to turn off the first transistor T1 and the second transistor T2. Then, a driving current may be applied to the second node N2 through the turned-on driving transistor DRT. Accordingly, the voltage of the second node N2 may gradually increase, and the voltage of the first node N1 coupled to the second node N2 by the storage capacitor Cst may increase in response to the increase in the voltage of the second node N2. Accordingly, the gate-source voltage Vgs of the driving transistor DRT is maintained at the voltage programmed during the programming time t2.

When a voltage of the second node N2 increases to a driving voltage of the light-emitting element LD, the light-emitting element LD may be turned on during the light-emitting time t4. During the light emission time t4, a driving current corresponding to the gate-source voltage Vgs of the driving transistor DRT may flow to the light-emitting element LD, and the light-emitting element LD may emit light with luminance corresponding to the driving current.

During the blank time BT, the electrical characteristics of the pixel PX may be sensed. The electrical characteristics may include, for example, the threshold voltage and mobility of the driving transistor DRT, the driving voltage of the light-emitting element LD, etc. The blank time BT may include a sensing time t5 and a sampling time t6.

During the sensing time t5, at least one of the scan signal SC and the sensing signal SN may be at turned-on level. Although not illustrated, according to an embodiment, the sensing data voltage Vdata may be applied to the first node N1 and/or the sensing reference voltage VpreS may be applied to the second node N2. After the sensing time t5, the voltage of the second node N2 may be saturated to a desired state to sense the electrical characteristics of the pixel PX.

When the second node N2 within the pixel PX reaches a voltage state reflecting the characteristic value of the desired circuit element(such as the driving transistor DRT and/or the light- emitting element LD), the sampling switch SAM may be turned on. During the sampling time t6, a sensing signal, such as voltage and/or current, output to the readout line RVL through the turned-on sampling switch SAM may be applied to the data driving circuit 30. The analog-to-digital converter ADC may convert a voltage of the connected readout line RVL into digital data to generate the sensing data Vsen and transmit the sensing data Vsen to the timing controller 10.

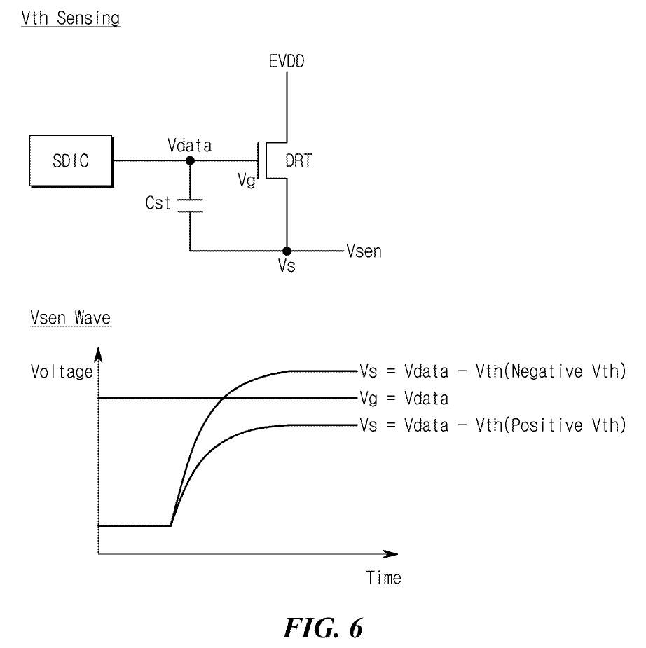

FIG. 6 is a view illustrating a threshold voltage sensing method for a driving transistor of the display device according to one embodiment.

During the threshold voltage sensing driving for the driving transistor DRT, the first node N1 and the second node N2 of the driving transistor DRT are initialized to the sensing data voltage Vdata and the sensing reference voltage VpreS, respectively. Then, when the sensing reference voltage switch SPRE is turned off and the second node N2 floats, the driving transistor DRT enters a source follower state.

The driving transistor DRT being in the source follower state responds to the sensing data voltage Vdata to apply the driving current to the second node N2 until the gate-source voltage reaches the threshold voltage Vth. Accordingly, the voltage of the second node N2 may gradually increase. When the gate-source voltage of the driving transistor DRT saturates to the threshold voltage Vth, the voltage of the second node N2 may correspond to a difference between the sensing data voltage Vdata and the threshold voltage Vth.

When the voltage of the second node N2 saturates, the data driving circuit 30 senses the voltage of the second node N2 through the sampling switch SAM. The voltage Vsen sensed by the data driving circuit 30 may be a voltage (Vdata-Vth) obtained by subtracting the threshold voltage Vth of the driving transistor DRT from the sensing data voltage Vdata.

In this case, when the threshold voltage Vth has a negative value (or when the threshold voltage Vth is negatively shifted), the sensed voltage Vsen may have a higher voltage value than the sensing data voltage Vdata. On the other hand, when the threshold voltage Vth has a positive value (or when the threshold voltage Vth is positively shifted), the sensed voltage Vsen may have a lower voltage than the sensing data voltage Vdata.

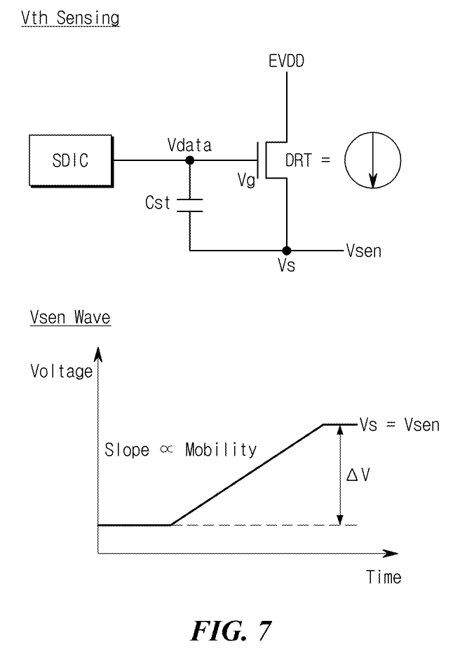

FIG. 7 is a view for describing a mobility sensing method for the driving transistor of the display device according to one embodiment.

During the mobility sensing driving for the driving transistor DRT, the first node N1 and the second node N2 of the driving transistor DRT are initialized to the sensing data voltage Vdata and the sensing reference voltage VpreS, respectively. Then, the sensing reference voltage switch SPRE and the first transistor T1 are turned off, allowing the first node N1 and the second node N2 to float.

The driving transistor DRT applies a driving current to the second node N2 in response to the sensing data voltage Vdata. Accordingly, the voltage of the second node N2 may gradually increase. During a predetermined time, a voltage rise amount ΔV of the second node N2 is a voltage rise rate and varies depending on the current capability, that is, the mobility, of the driving transistor DRT. That is, the higher the mobility of the driving transistor DRT, the more rapidly the voltage of the second node N2 of the driving transistor DRT rises, and the greater the voltage rise amount ΔV during a predetermined time.

After the voltage of the second node N2 of the driving transistor DRT rises during the predetermined time, the sampling switch SAM may be turned on. The data driving circuit 30 senses the increased voltage of the second node N2 through the sampling switch SAM. The voltage Vsen sensed by the data driving circuit 30 may have a magnitude corresponding to the mobility of the driving transistor DRT.

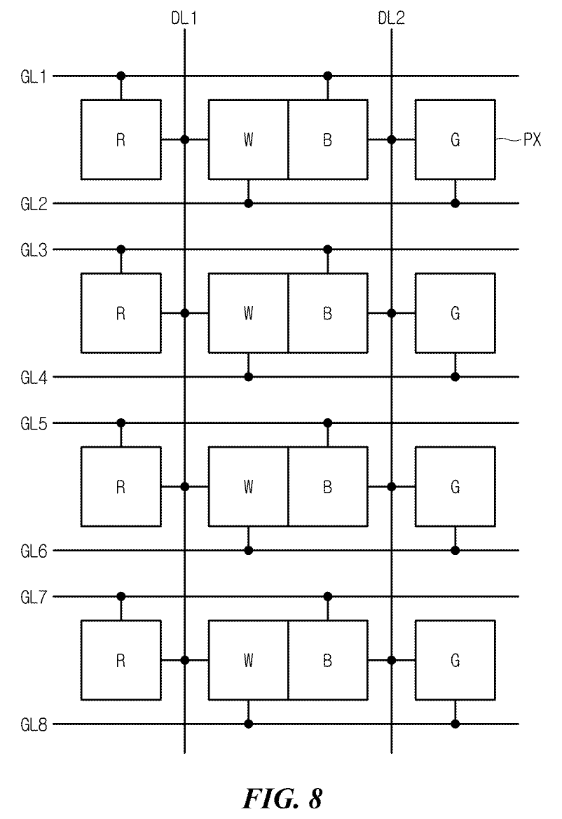

FIG. 8 is a view illustrating a pixel structure driven using a double rate driving (DRD) method in the display device according to one embodiment.

Referring to FIG. 8, pixels PX may be disposed in a matrix form on the display panel 50 (see FIG. 1) according to one embodiment. The pixels PX may include a red pixel R, a green pixel G, a blue pixel B, and a white pixel W.

In one embodiment, the pixels PX may be connected to the data driving circuit 30 (see FIG. 1) using a DRD method. That is, a single data line DL may be shared between two or more pixels R, G, B, and W that emit light of different colors.

In the illustrated embodiment, the red pixels R and white pixels W disposed adjacent to each other may share a single data line DL1, and green pixels G and blue pixels B disposed adjacent to each other may share a single data line DL2. The data lines DL1 and DL2 may be disposed one by one for every two pixel columns and may extend in the column direction between two adjacent pixel columns that share the data lines DL1 and DL2.

In this embodiment, the pixels R, G, B, and W that share the single data lines DL1 and DL2 may be connected to the same gate lines GL1 to GL8. For example, the red pixel R and the white pixel W, which share the first data line DL1, may be connected to the same gate line GL1, and the green pixel G and the blue pixel B, which share the second data line DL2, may be connected to the same gate line GL2.

Two of the gate lines GL1 to GL8 may be disposed for each pixel row. One of the two gate lines GL1 to GL2 connected to one pixel row may extend in a row direction from one side (e.g., an upper side) of the corresponding pixel row, and the other may extend in the row direction from the other side (e.g., a lower side) of the corresponding pixel row.

The arrangement of the pixels PX is not limited to that illustrated. For example, the colors of the pixels PX that share the single data lines DL1 and DL2 may be different from colors as shown in FIG. 8.

In the DRD structure, the data voltage Vdata (see FIG. 4) is supplied to two connected pixels R and W/B and G via the single data lines DL1 and DL2 during one horizontal time. In this time, the two of the gate lines GL1 to GL8 are driven in a time division manner during one horizontal time. That is, gate signals may be sequentially applied to the two of the gate lines GL1 to GL8 during one horizontal time. The display panel 50 is driven at substantially double the frequency.

In order to minimize flicker and reduce power consumption, the scan signal SC may be controlled so that the data voltage Vdata is alternately applied to the pixels PX disposed at both sides of the single data line DL.

In such a DRD method, in order to minimize flicker and reduce power consumption, a data voltage Vdata having a reversed polarity may be applied to one pixel row or two or more pixel rows. For example, a data voltage Vdata having a positive voltage may be applied to a first pixel row, and a data voltage Vdata having a negative voltage may be applied to a second pixel row. Alternatively, a data voltage Vdata having a reversed polarity may be applied between adjacent pixel rows.

During a transition section in which the polarity of the data voltage Vdata is reversed, the temperature of the data driving circuit 30 may rise. Such a temperature rise may be accelerated in a DRD structure with frequent transitions and in the pattern of the image data DATA (see FIG. 1). Accordingly, the temperature rise may be predicted through pattern analysis of the image data DATA output from the data driving circuit 30, but since a connection relationship between the data driving circuit 30 and the pixel PX varies for each display device 1 (see FIG. 1) and the polarity inversion method is set differently, it may be difficult to analyze the transition section based on the pattern of the image data DATA.

Hereinafter, a method of preventing heat generation in the data driving circuit 30 using the result of sensing the electrical characteristics of the pixel PX will be described in detail.

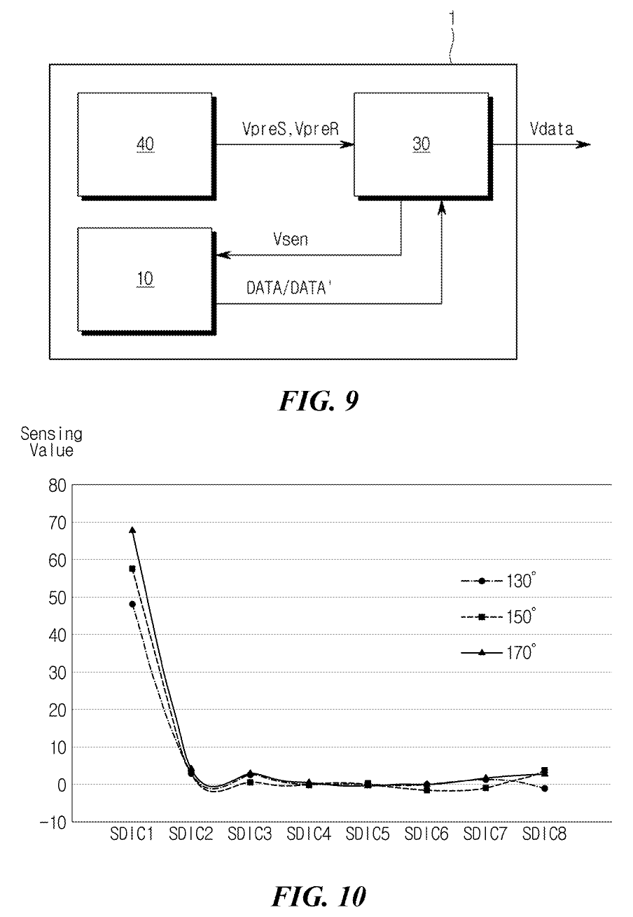

FIG. 9 is a block diagram illustrating some components of the display device according to one embodiment.

Referring to FIG. 9, the display device 1 according to one embodiment may include the timing controller 10, the data driving circuit 30, and the power supply unit 40.

The power supply unit 40 may adjust the DC input voltage Vin supplied from a host system or the like and apply the adjusted DC input voltage to the data driving circuit 30. For example, the power supply unit 40 may apply the display reference voltage VpreR to the data driving circuit 30 during display driving and apply the sensing reference voltage VpreS to the data driving circuit 30 during sensing driving. The display reference voltage VpreR and the sensing reference voltage VpreS may have fixed voltage values.

The data driving circuit 30 may convert the image data DATA output from the timing controller 10 into the data voltage Vdata and output the data voltage Vdata to the display panel 50. In this case, the image data DATA may include display image data to be displayed through the display panel 50 during display driving and/or sensing image data applied to the display panel 50 (see FIG. 1) to sense the pixel PX (see FIG. 1) during sensing driving.

During sensing driving, the data driving circuit 30 may transmit the sensing data Vsen including the electrical characteristic values of the pixel PX to the timing controller 10. The electrical characteristics may be sensed in the same manner as that described with reference to FIGS. 6 and 7 and may include a threshold voltage, mobility, and the like of the driving transistor DRT.

The timing controller 10 may compensate for the image data DATA based on the sensing data Vsen acquired from the data driving circuit 30. For example, the timing controller 10 may determine a compensation value, such as an offset voltage and/or a scale factor, based on the sensing result.

The timing controller 10 may generate compensated image data DATA’ by applying a compensation value to the image data DATA. When the compensated image data DATA’ is transmitted to the data driving circuit 30, the data driving circuit 30 may generate the data voltage Vdata based on the compensated image data DATA’.

In another embodiment, the timing controller 10 may transmit the image data DATA before compensation and the compensation value to the data driving circuit 30. In this embodiment, the image data DATA may be compensated through the data driving circuit 30.

In one embodiment, the timing controller 10 may vary at least one of a period, voltage level, and frequency of the image data DATA based on the sensing data Vsen. For example, when a voltage value of the sensing data Vsen is greater than or equal to a preset threshold value, the timing controller 10 may increase the period of the image data DATA or decrease the voltage level and/or frequency of the image data DATA.

In response to the varied period, voltage level, and/or frequency, the period, voltage level, and/or frequency of the data voltage Vdata output from the data driving circuit 30 may vary. Accordingly, the variation of the period, voltage level, and/or frequency of the image data DATA may be equivalent to the variation of the period, voltage level, and/or frequency of the data voltage Vdata provided to the pixels PX from the data driving circuit 30.

By varying the period, voltage level, and/or frequency of the data voltage Vdata, it is possible to prevent a temperature rise in the data driving circuit 30. Hereinafter, the above description will be made in more detail.

FIG. 10 is a view illustrating changes in electrical characteristics according to changes in temperature of a display panel.

As described with reference to FIGS. 4, 6 and 7, in one embodiment, the timing controller 10 may sense the threshold voltage and/or mobility of the driving transistor DRT provided in the pixels PX.

Specifically, during sensing operation, an electrical signal reflecting the electrical characteristics of the driving transistor DRT and/or the light-emitting element LD may be input to the data driving circuit 30 through the driving readout line RVL. The data driving circuit 30 converts the input sensing signal into the sensing data Vsen and provides the sensing data Vsen to the timing controller 10. The sensing data Vsen is digital data and may have a predetermined sensing value (voltage and/or current level) corresponding to the sensing signal.

In one embodiment, the value of the sensing data Vsen acquired through the data driving circuit 30 may not only be determined based on the degree of deterioration of the pixel PX, but may also vary depending on the temperature of the data driving circuit 30. For example, even when the characteristic values of the pixel PX are the same, when the temperature of the data driving circuit 30 rises, the sensing value included in the sensing data Vsen may increase.

FIG. 10 illustrates changes in sensing value as temperature rises. Specifically, FIG. 10 illustrates that, among a plurality of source driving integrated circuits SDIC1 to SDIC8 constituting the data driving circuit 30, when a temperature of a first source driving integrated circuit SDIC1 is higher than that of other source driving integrated circuits SDIC2 to SDIC8, the sensing value increases rapidly.

Such a deviation in the sensing value increases further as the temperature of the first source driving integrated circuit SDIC1 increases. Accordingly, when the value of the sensing data Vsen (i.e., the sensing value) is greater than (or greater than or equal to) a preset threshold value, it may be determined that the temperatures of the source driving integrated circuits SDIC1 to SDIC8 that have acquired the corresponding sensing data Vsen has risen.

The rise in temperatures of the source driving integrated circuits SDIC1 to SDIC8 may be caused by, for example, a transition of the data voltage Vdata as described with reference to FIG. 8. When an image of the same grayscale is output during multiple frames, even when the data voltage Vdata is not output to the pixel PX, the pixel PX may emit light with the same grayscale using the data voltage Vdata of the corresponding grayscale stored in advance.

However, in the DRD method, the data voltage Vdata may be output for a transition even while an image of the same grayscale is output. As an area and resolution of the display panel 50 increase, the amount of the image data DATA displayed through the display panel 50 increases, and transitions may occur more frequently. Such transitions may cause a temperature rise and a consequent performance degradation of the corresponding source driving integrated circuits SDIC1 to SDIC8.

In order to prevent a temperature rise in the source driving integrated circuits SDIC1 to SDIC 8, at least one of the period, voltage level, and frequency of the image data DATA may be controlled when the sensing data Vsen is greater than or equal to the preset threshold value, that is, when the temperature rise is detected. For example, when the temperature rise is detected, the timing controller 10 may increase the period of the image data DATA or decrease at least one of the voltage level and frequency.

When the period of the image data DATA increases, output intervals of the data voltages Vdata of the source driving integrated circuits SDIC1 to SDIC 8 correspondingly increase, thereby preventing a temperature rise. In addition, when the voltage of the image data DATA decreases or its frequency decreases, the voltage of the data voltage Vdata decreases or its frequency decreases, thereby preventing the temperature rise in the source driving integrated circuits SDIC1 to SDIC 8.

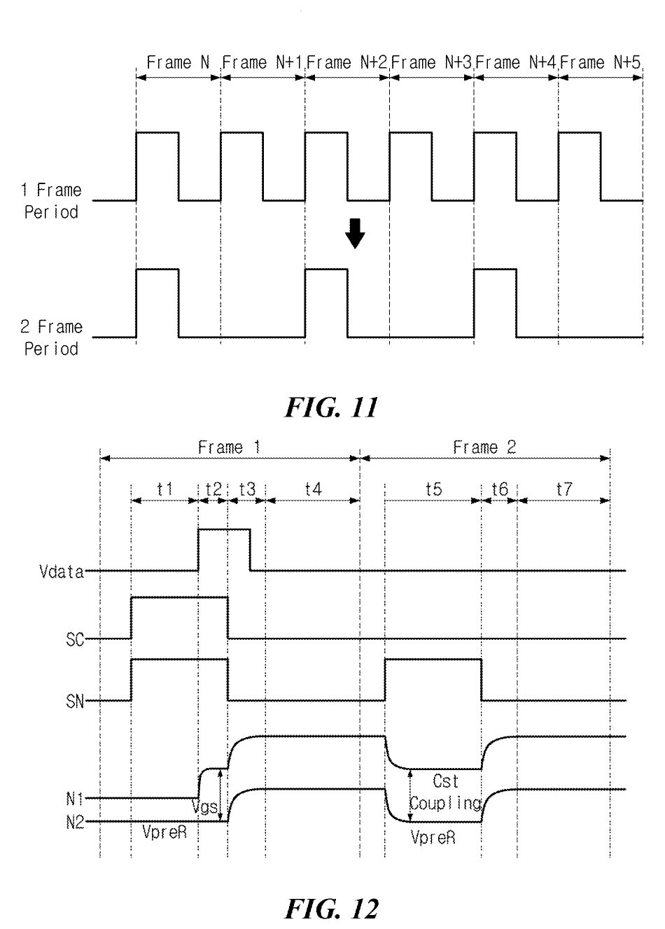

FIG. 11 is a view illustrating a method of varying a period of image data according to one embodiment.

In one embodiment, when the sensing value of the sensing data Vsen is greater than or greater than or equal to the preset threshold value, the timing controller 10 may increase an output period of the image data DATA as illustrated in FIG. 11. In this case, the output period of the image data DATA may be increased by increasing a length of a time (off time) in which the image data DATA is not output in a state in which an output pulse width (on time) of the image data DATA is fixed.

For example, in a default mode, the timing controller 10 may control the output period of the image data DATA to a first frame period. Here, the first frame period may include one frame. That is, in the default mode, the timing controller 10 may output the image data DATA for each frame.

When the sensing value is greater than or equal to the preset threshold value, the timing controller 10 may control the output period of the image data DATA to a second frame period. Here, the second frame period may include two or more frames.

For example, the second frame period may include two frames. In this embodiment, the timing controller 10 may output the image data DATA every two frames.

The output period of the image data DATA may be preset according to a sensing value or a range of sensing values. For example, as the sensing value increases, the output period of the image data DATA may increase accordingly. A relationship between the sensing value and the output period of the image data DATA may be preset and stored in a lookup table or the like.

During frames in which the image data DATA is not output, the data voltage Vdata may not be output from the data driving circuit 30. The pixel PX may emit light with a luminance corresponding to the data voltage Vdata pre-stored during a previous frame. Accordingly, it is possible to prevent heat generation by increasing the current output period of the data driving circuit 30, thereby reducing the temperature of the data driving circuit 30.

FIG. 12 is a timing diagram illustrating a pixel driving method using the method of varying a period of an image data.

Referring to FIG. 12, the pixel PX may be driven on a frame-by-frame basis. When the sensing value is greater than or equal to the preset threshold value, the output period of the image data DATA is two frames and may vary. For example, the image data DATA may be output from the timing controller 10 to the data driving circuit 30 during a first frame Frame 1, and the image data DATA may not be output from the timing controller 10 to the data driving circuit 30 during a second frame Frame 2. In this embodiment, the data driving circuit 30 outputs the data voltage Vdata to the pixel PX based on the image data DATA applied from the timing controller 10 during the first frame Frame 1 and does not output the data voltage Vdata during the second frame Frame 2.

During the first frame, the pixel PX is driven according to the initialization time t1, the programming time t2, the tracking time t3, and the light emission time t4. The specific driving method for each time is as described with reference to FIG. 5. After the light emission time t4, the sensing driving described with reference to FIG. 5 may be performed.

During the second frame, the pixel PX is driven according to the initialization time t5, the tracking time t6, and the light emission time t7.

During the initialization time t5, the second transistor T2 is turned on, and the display reference voltage switch RPRE is turned on by the sensing signal SN at a turn-on level. Accordingly, the second node N2 may be initialized to the display reference voltage VpreR.

During the initialization time t5, the scan signal SC is applied at the turn-off level, and the first transistor T1 is turned off. The first node N1 is coupled to the second node N2 through the storage capacitor Cst. When the voltage of the second node N2 is initialized to the display reference voltage VpreR, the voltage of the coupled first node N1 may decrease in response to the change in the voltage of the second node N2. In this case, the difference in voltage between the first node N1 and the second node N2, that is, the gate-source voltage Vgs of the driving transistor DRT, is maintained at the voltage programmed during the previous frame.

During the tracking time t6, the sensing signal SN at the turn-off level is applied to turn off the second transistor T2. Then, a driving current may be applied to the second node N2 through the driving transistor DRT, which is turned on by the pre-stored gate-source voltage Vgs. Accordingly, the voltage of the second node N2 may gradually increase, and the voltage of the first node N1 coupled to the second node N2 by the storage capacitor Cst may increase in response to the increase in the voltage of the second node N2. During the tracking time t6, the gate-source voltage Vgs is maintained at the voltage programmed during the previous frame.

When the voltage of the second node N2 increases to the driving voltage of the light-emitting element LD, the light-emitting element LD may be turned on during the light emission time t7. During the light emission time t7, a driving current corresponding to the gate-source voltage Vgs of the driving transistor DRT may flow to the light-emitting element LD, and the light-emitting element LD may emit light with luminance corresponding to the driving current.

In this way, when the output period of the image data DATA varies, the pixel PX may be driven on a frame-by-frame basis, and a plurality of frames may be composed of a frame in which the data voltage Vdata is written in the pixel PX (the first frame, a scan and sensing frame) and a frame in which the data voltage Vdata is not written (the second frame, a sensing frame). The second frame is subsequent to the first frame and may include one or more frames depending on the temperature of the data driving circuit 30.

During the second frame, the data voltage Vdata is not programmed. Instead, during the second frame, only the operation of initializing the second node N2 is performed by turning on only the second transistor T2. Even when the voltage of the second node N2 is initialized, the gate-source voltage Vgs of the driving transistor DRT is maintained at the voltage that is the same as in the previous frame by the storage capacitor Cst. Since, during the second frame, the programming operation of the data voltage Vdata is not included, only the second transistor T2, which is a sensing transistor, may be controlled to be turned on, and only the sensing driving may be performed during the blank time BT, the second frame may be referred to as a sense only frame.

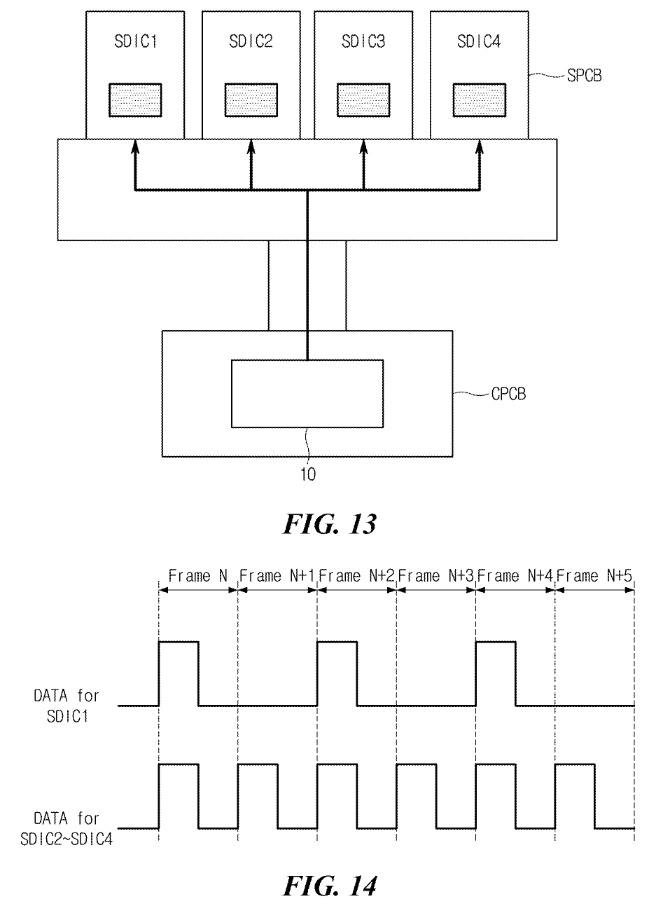

FIG. 13 is a view illustrating an example of a connection structure between a plurality of source driving integrated circuits disposed on a source printed circuit board and a timing controller disposed on a control printed circuit board. FIG. 14 is a view illustrating a method of varying a period of image data for the source driving integrated circuits illustrated in FIG. 13.

Referring to FIG. 13, the timing controller 10 may be disposed on the control printed circuit board CPCB. The image data DATA (see FIG. 11) generated by the timing controller 10 is transmitted to the data driving circuit 30 (see FIG. 11) through the source printed circuit board SPCB.

In one embodiment, the data driving circuit 30 may include a plurality of source driving integrated circuits SDIC1 to SDIC4. In this embodiment, the timing controller 10 may individually detect whether a temperature rise has occurred for each of the source driving integrated circuits SDIC1 to SDIC4 based on the sensing data Vsen (see FIG. 11) acquired from each of the source driving integrated circuits SDIC1 to SDIC4.

When the temperature rise is detected for some of the plurality of source driving integrated circuits SDIC1 to SDIC4, the timing controller 10 may independently and individually vary the output period of the image data DATA for each of the source driving integrated circuits SDIC1 to SDIC4. For example, when the temperature rise is detected in the first source driving integrated circuit SDIC1, the timing controller 10 may increase the output period of the image data DATA for the first source driving integrated circuit SDIC1. In addition, the output periods of the image data DATA for the remaining source driving integrated circuits SDIC2 to SDIC4 may not vary.

The output period of the image data DATA controlled in this way is illustrated in FIG. 14. In the example illustrated in FIG. 14, the timing controller 10 outputs image data DATA for the first source driving integrated circuit SDIC1 every two frames and outputs the image data DATA for the remaining source driving integrated circuits SDIC2 to SDIC4 every frame.

The pixels PX connected to the first source driving integrated circuit SDIC1 are driven based on scan and sensing frames and sensing frames as illustrated in FIG. 12. In this case, the pixels PX (see FIG. 1) connected to the first source driving integrated circuit SDIC1 may operate similarly to a variable refresh rate (VRR) mode.

On the other hand, the second to fourth source driving integrated circuits SDIC2 to SDIC4 are driven based on the scan and sensing frames.

Consequently, in this embodiment, the driving frequency of the display panel 50 (see FIG. 1) is substantially unchanged, and the output period of the image data DATA varies on a frame-by-frame basis for only the source driving integrated circuit SDIC1 in which a temperature rise is detected. Since the driving frequency of the display panel 50 does not vary, even when the input/output period of the image data DATA varies, the image quality of the display panel 50 is not changed, and the temperature rise of the data driving circuit 30 can be prevented.

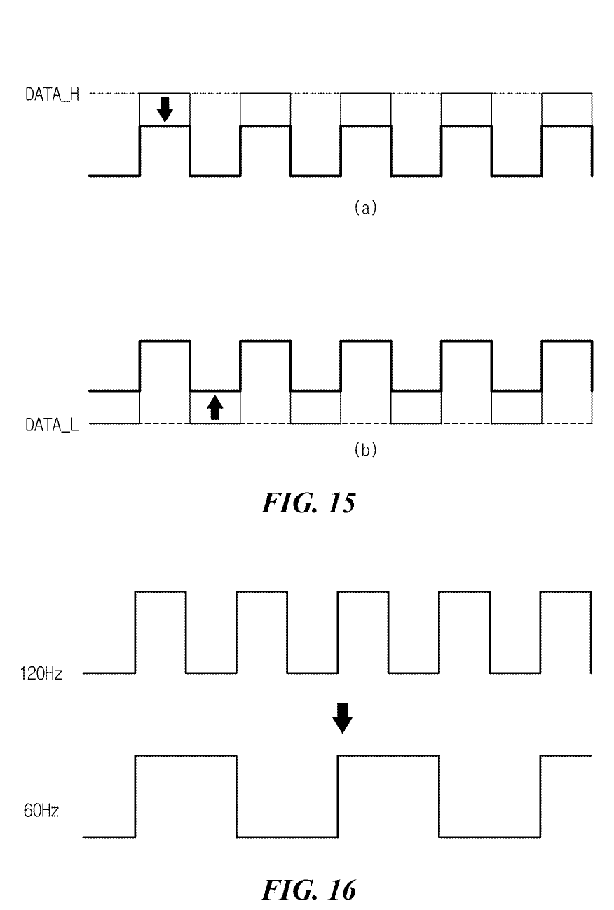

FIG. 15 is a view illustrating a method of varying a voltage level of the image data according to one embodiment.

In one embodiment, when the sensing value of the sensing data Vsen is greater than or greater than or equal to the preset threshold value, the timing controller 10 may reduce the voltage level (peak-to-peak value) of the image data DATA by decreasing a high level DATA_H of the image data DATA (a case of FIG. 15A) or increasing a low level DATA_L of the image data DATA (a case of FIG. 15B) as illustrated in FIG. 15.

The high level DATA_H of the image data DATA may be controlled by decreasing a compensation value that is added to, subtracted from, or multiplied by the image data. In addition, the low level DATA_L of the image data DATA may be controlled by increasing a black offset voltage (horizontal crosstalk (HCT) compensation voltage) of the image data DATA. However, the embodiment is not limited thereto.

When a voltage level of the image data DATA decreases, the range of the data voltage Vdata output from the source driving integrated circuit SDIC based on the image data DATA decreases. Accordingly, by reducing the current value output from the source driving integrated circuit SDIC, it is possible to prevent heat generation, and consequently, the temperature of the source driving integrated circuit SDIC can be reduced.

FIG. 16 is a view illustrating a method of varying a frequency of the image data according to one embodiment.

In one embodiment, when the sensing value of the sensing data Vsen is greater than or greater than or equal to the preset threshold value, the timing controller 10 may decrease the frequency (output frequency) of the image data DATA as illustrated in FIG. 16. For example, when the frequency of the image data DATA is 120 Hz in the default state, the timing controller 10 may reduce the frequency of the image data DATA to 60 Hz when the sensing value is greater than or equal to the preset threshold value.

Here, a case is illustrated in which the timing controller 10 reduces the frequency of the image data DATA while maintaining the constant level of the image data DATA. However, in other embodiments, the timing controller 10 may also change both the voltage level and frequency of the image data DATA based on the sensing value. For example, the frequency of the image data DATA may decrease simultaneously with a decrease in the high level DATA_H, or the frequency of the image data DATA may decrease simultaneously with an increase in the low level DATA_L. Alternatively, the frequency of the image data DATA may decrease simultaneously with a decrease in the high level DATA_H and an increase in the low level DATA_L.

When the frequency of the image data DATA decreases, the processing speed of the image data DATA in the source driving integrated circuit SDIC decreases, resulting in a decrease in the output frequency of the data voltage Vdata from the source driving integrated circuit SDIC. Accordingly, by reducing the frequency of current output from the source driving integrated circuit SDIC, it is possible to prevent heat generation, and consequently, the temperature of the source driving integrated circuit SDIC can be reduced.

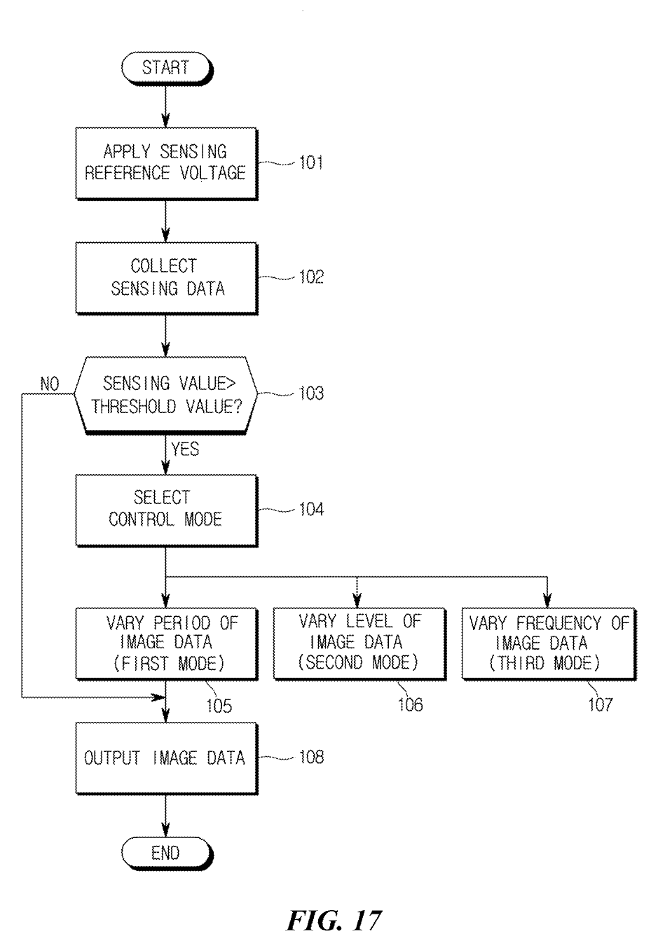

FIG. 17 is a flowchart illustrating a method of driving a display device according to one embodiment.

Referring to FIG. 17, a method of driving the display device 1 according to one embodiment may include operation 101 of applying a sensing reference voltage to the pixels PX through the data driving circuit 30, operation 102 of collecting the sensing data Vsen from the data driving circuit 30, operation 103 of comparing a sensing value of the sensing data with a preset threshold value, operation 104 of selecting a control mode when the sensing value is greater than (or greater than or equal to) the threshold value, operation 105 of varying a period of the image data DATA according to the control mode, operation 106 of varying a voltage level of the image data DATA according to the control mode, or operation 107 of varying a frequency of the image data DATA according to the control mode, and operation 108 of outputting the image data DATA according to the controlled period/voltage level/frequency.

The operation 101 of applying the sensing reference voltage may be performed, for example, during the blank time BT. In response to the sensing reference voltage, the data driving circuit 30 may sense the electrical characteristics of the pixel PX and output the sensing data Vsen.

The threshold value may be determined based on the temperature of the data driving circuit 30 and changes in the sensing value. The threshold value may correspond to the changed sensing value when it is determined that the temperature of the data driving circuit 30 may rise, causing deterioration. This threshold value may be appropriately determined through experiments and/or simulations.

The control mode may be determined based on the type, driving method, degree of increase in the sensing value, degree of a temperature rise of the data driving circuit 30 estimated from the sensing value, and the like of the display device 1. For example, during the initial operation, the display device 1 may be driven in the default mode, and depending on the changes in the sensing value, the display device 1 may be driven in a first mode that varies the period of the image data DATA, a second mode that varies the voltage level thereof, or a third mode that varies the frequency thereof. Depending on the variation in the sensing value, one or more of the first to third modes may be implemented simultaneously.

As described above, the control of the period, voltage level, and frequency of the image data DATA may be equivalent to the control of the period, voltage level, and frequency of the data voltage Vdata.

In the display device and the method of driving a display device according to the embodiments, it is possible to reduce the temperature rise in the data driving circuit and the display panel due to the output and transition of the data voltage.

In the display device and the method of driving a display device according to the embodiments, by reducing the number of data voltage outputs without changing the driving frequency, it is possible to prevent image quality degradation and reduce the temperature rise in the data driving circuit.

In the display device and the method of driving a display device according to the embodiments, it is possible to prevent an increase in load, heat generation, and operational risks due to the temperature rise in the data driving circuit and improve the reliability of components.

In the display device and the method of driving a display device according to the embodiments, the pattern analysis of the image data applied to the data driving circuit is not required, and instead the temperature of the data driving circuit is predicted, and the image data is controlled based on pixel sensing results, and thus it is possible to prevent the temperature rise in the data driving circuit without using complex algorithms.

Although the embodiments of the present disclosure have been described above with reference to the accompanying drawings, those skilled in the art to which the present disclosure pertains will be able to understand that the above-described technical configuration of the present disclosure can be carried out in other specific forms without changing the technical spirit or essential features thereof. Accordingly, it should be understood that the above embodiments are illustrative and not restrictive in all aspects. In addition, the scope of the present disclosure is defined by the claims to be described below rather than the detailed description. In addition, the meaning and scope of the claims and all changed or modified forms derived from the equivalent concept should be construed as being included in the scope of the present disclosure.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A display device comprising:
a display panel on which pixels are disposed;
a gate driving circuit configured to apply a gate signal to the pixels through a gate line;
a data driving circuit configured to convert image data and apply the converted image data to the pixels through a data line, and convert sensing signals output from the pixels through a readout line into sensing data and output the sensing data; and
a timing controller configured to control an output of the image data based on a sensing value of the sensing data,
wherein the timing controller is configured to increase an output period of the image data on a frame-by-frame basis when the sensing value is greater than or equal to a preset threshold value.

2. The display device of claim 1, wherein the sensing value varies depending on a temperature of the data driving circuit.

3. The display device of claim 1, wherein the data driving circuit includes a plurality of source driving integrated circuits, each of which configured to generate sensing data for corresponding pixels, and
when the sensing values of at least some of the plurality of source driving integrated circuits are greater than or equal to the preset threshold value, the timing controller is configured to control an output period of the image data for the at least some of the source driving integrated circuits with a second frame period and controls an output period of the image data for the remaining ones of the source driving integrated circuits with a first frame period.

4. The display device of claim 3, wherein the first frame period includes one frame, and
the second frame period includes two or more frames.

5. The display device of claim 4, wherein the two or more frames include:
a first frame in which the data voltage is programmed in the pixels; and
at least one second frame in which the data voltage is not programmed in the pixels.

6. The display device of claim 5, wherein each of the pixels includes:
a driving transistor connected between a high potential driving voltage and a second node and having a gate electrode connected to a first node;
a first transistor connected between a corresponding data line and the first node and having a gate electrode receiving a scan signal through a first gate line;
a second transistor connected between the readout line and the second node and having a gate electrode receiving a sensing signal through a second gate line; and
a light-emitting element connected between the second node and a low potential driving voltage.

7. The display device of claim 6, wherein the first frame includes:
a first time in which the scan signal at a turn-on level is applied to the first gate line, the sensing signal at a turn-on level is applied to the second gate line, and a reference voltage is applied to the readout line;
a second time in which the data voltage is applied to the data line;
a third time in which the scan signal and the sensing signal are applied at a turn-off level, and voltages of the first node and the second node are increased; and
a fourth time in which the light-emitting element emits light.

8. The display device of claim 6, wherein the second frame includes:
a fifth time in which the sensing signal at a turn-on level is applied to the second gate line and a reference voltage is applied to the readout line;
a sixth time in which the sensing signal is applied at a turn-off level and voltages of the first node and the second node increase; and
a seventh time in which the light-emitting element emits light.

9. The display device of claim 3, wherein, while the output period of the image data for the plurality of source driving integrated circuits varies, a driving frequency of the display panel is fixed.

10. The display device of claim 1, wherein at least two pixels disposed in different pixel columns are electrically connected to the data driving circuit through a single data line.

11. The display device of claim 1, wherein the timing controller is configured to further vary at least one of a voltage level or a frequency of the image data based on the sensing value.

12. The display device of claim 11, wherein, when the sensing value is greater than or equal to the preset threshold value, the timing controller decreases a high level of the image data or increases a low level of the image data.

13. The display device of claim 11, wherein, when the sensing value is greater than or equal to the preset threshold value, the timing controller decreases the frequency of the image data.

14. A method of driving a display device including a display panel on which pixels are disposed, a gate driving circuit configured to apply a gate signal to the pixels through a gate line, and a data driving circuit configured to convert image data and apply the converted image data to the pixels through a data line, the method comprising:
controlling the data driving circuit to sense an electrical characteristic of the pixels;
varying an output period of the image data on a frame-by-frame basis in response to a sensing value obtained through the sensing; and
programming, by the data driving circuit, a data voltage in the pixels according to the varied output period.

15. The method of claim 14, wherein the varying of the output period of the image data includes:
comparing the sensing value with a threshold value; and
increasing an output period of the image data when the sensing value is greater than or equal to the preset threshold value.

16. The method of claim 14, wherein the data driving circuit includes a plurality of source driving integrated circuits, each of which generates sensing data for corresponding pixels, and
the varying of the output period of the image data includes:
controlling an output period of the image data for at least some of the source driving integrated circuits with a second frame period when sensing values of the at least some of the plurality of source driving integrated circuits are greater than or equal to the preset threshold value; and
controlling the output period of the image data for the remaining ones of the source driving integrated circuits with a first frame period.

17. The method of claim 16, wherein the first frame period includes one frame, and
the second frame period includes two or more frames.

18. The method of claim 17, wherein the two or more frames include:
a first frame in which the data voltage is programmed in the pixels; and
at least one second frame in which the data voltage is not programmed in the pixels.

19. The method of claim 18, wherein each of the pixels includes:
a driving transistor connected between a high potential driving voltage and a second node and having a gate electrode connected to a first node;
a first transistor connected between a corresponding data line and the first node and having a gate electrode receiving a scan signal through a first gate line;
a second transistor connected between the readout line and the second node and having a gate electrode receiving a sensing signal through a second gate line; and
a light-emitting element connected between the second node and a low potential driving voltage.

20. The method of claim 19, wherein the programming of the data voltage in the pixels includes:
during the first frame,
applying a scan signal at a turn-on level to the first gate line, a sensing signal at a turn-on level to the second gate line, and a reference voltage to the read-out line;
applying the data voltage to the data line;
increasing voltages of the first node and the second node by applying the scan signal and the sensing signal at a turn-off level; and
causing the light-emitting element to emit light, and
during the second frame,
applying a sensing signal at a turn-on level to the second gate line and applying a reference voltage to the readout line;
increasing the voltages of the first node and the second node by applying the sensing signal at a turn-off level; and
causing the light-emitting element to emit light.
